(19) United States
(12) Patent Application Publication
(10) Pub. No.: US 2020/0213910 A1
(43) Pub. Date: Jul. 2, 2020

(54) ADVERTISING INTERNET CONNECTION QUALITY

(71) Applicant: Qualcomm Incorporated, San Diego, CA (US)

(72) Inventors: Dustin Andrew BROWN, San Diego, CA (US); Rajeev KUMAR, San Diego, CA (US)

(21) Appl. No.: 16/235,371

(22) Filed: Dec. 28, 2018

(51) Int. Cl. H04W 28/20; H04W 24/08; H04L 12/26; H04W 72/04; H04W 28/02; H04W 88/10

(52) U.S. Cl. CPC H04W 28/20; H04W 24/08; H04L 43/0864; H04W 84/12; H04W 28/0284; H04W 88/10; H04W 72/0446

(57) ABSTRACT

This disclosure provides systems, devices, apparatus and methods, including computer programs encoded on storage media, for wireless communication. In one aspect, an apparatus for wireless communication may include a processing system configured to generate a first frame including an indication of an internet connection quality between the apparatus and a network, and a first interface configured to output the first frame for transmission to one or more wireless nodes that are unassociated with the apparatus.

### TECHNICAL FIELD

This disclosure relates generally to wireless communications, and more specifically, to advertising internet connection quality.

### DESCRIPTION OF THE RELATED TECHNOLOGY

Wireless communication systems are widely deployed to provide various types of communication content, such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

A wireless network, for example, a wireless local area network (WLAN), such as a network operating according to one of the IEEE 802.11 family of standards (“Wi-Fi”) may include a number of access points, each simultaneously supporting communication for multiple wireless devices. The access point may be coupled to a network, such as the Internet, and may enable a wireless devices to communicate via the network, and/or to communicate with other devices coupled to the AP. A wireless device may communicate with the network bi-directionally via the AP upon establishing a connection and association with the AP.

Access points may communicate with devices on downstream and upstream links. Each access point has a coverage range, which may be referred to as the coverage area of the access point. In WLANs, a basic service set (BSS) may provide a building-block of a WLAN. A simple BSS may include a single access point together with one or more wireless device often referred to as a station (STA), access device, mobile device, user equipment (UE), etc. Various stations, such as a cellular phone, laptop computer, tablet computer, desktop computer, etc., of a wireless network may have the capability to access two or more different networks. For example, a station may have access to different WLANs through different access points and/or may have access to one or more wireless wide area networks (WWANs) through a cellular data service provider. A station having access to multiple WLANs/WWANs may desire to connect to an access point having a reliable network connection.

### SUMMARY

The systems, methods and devices of this disclosure each have several innovative aspects, no single one of which is solely responsible for the desirable attributes disclosed herein.

Certain aspects of the subject matter described in this disclosure can be implemented in an apparatus for wireless communication. In some implementations, the apparatus includes a processing system configured to generate a first frame including an indication of an internet connection quality between the apparatus and a network, and a first interface configured to output the first frame for transmission to one or more wireless nodes that are unassociated with the apparatus.

In some implementations, the first frame can include an information element, the information element including the indication of the internet connection quality between the apparatus and the network. In some implementations, the information element can include a first field indicating a network reachability of the apparatus to the network. In some implementations, the processing system can be further configured to perform an internet reachability test to determine the network reachability. In some implementations, the information element can further include a second field indicating a round trip latency of the apparatus to the network. In some implementations, the processing system can be further configured to measure a round trip time of a packet to and from the network to determine the round trip latency.

In some implementations, the information element can further include a third field indicating a network uplink remaining available bandwidth. In some implementations, the processing system can be further configured to measure a throughput from the apparatus to the network to determine the network uplink remaining available bandwidth. In some implementations, the information element can further include a fourth field indicating a network downlink remaining available bandwidth. In some implementations, the processing system can be further configured to measure a throughput from the network to the apparatus to determine the downlink remaining available bandwidth.

In some implementations, the first frame can be a beacon frame. In some implementations, the apparatus can further include a second interface configured to obtain a second frame from the one or more wireless nodes, the second frame being a probe request, and the first frame being a probe response. In some implementations, the apparatus can further include a transmitter configured to transmit the first frame, and the apparatus can be configured as a wireless node.

Certain aspects of the subject matter described in this disclosure can be implemented in an apparatus for wireless communication. In some implementations, the apparatus can include a first interface configured to obtain from a first wireless node a first frame while the apparatus is unassociated with the first wireless node, the first frame including a first indication of an internet connection quality between the first wireless node and a network, and a processing system configured to determine whether to associate with the first wireless node based at least in part on the first indication of the internet connection quality between the first wireless node and the network.

In some implementations, the first frame can include an information element, the information element including the first indication of the internet connection quality between the apparatus and the network. In some implementations, the information element can include a first field indicating a network reachability of the apparatus to the network. In some implementations, the information element can further include a second field indicating a round trip latency of the apparatus to the network. In some implementations, the information element can further include a third field indicating a network uplink remaining available bandwidth. In some implementations, the information element can further include a fourth field indicating a network downlink remaining available bandwidth.

In some implementations, the first interface can be further configured to obtain from the first wireless node a QB SS load information element, and the processing system can be further configured to determine whether to associate with the first wireless node based at least in part on the QBSS load information element. In some implementations, the processing system can be further configured to: use the QBSS load information element and the first indication of the internet connection quality between the first wireless node and the network to determine a total internet connection quality between the apparatus and the network while the apparatus is unassociated with the first wireless node, and determine whether to associate with the first wireless node based at least in part on the total internet connection quality between the apparatus and the network.

In some implementations, processing system can be further configured to: compare the total internet connection quality between the apparatus and the network to a current network connection quality between the apparatus and the network, and determine whether to associate with the first wireless node based on the comparison of the total internet connection quality to the current network connection quality. In some implementations, the processing system can be further configured to generate an association request frame based on a determination to associate with the first wireless node, and the apparatus can further include a second interface configured to output the association request frame for transmission to the first wireless node.

In some implementations, the processing system can be further configured to refrain from associating with the first wireless node based on a determination to not associate with the first wireless node. In some implementations, the current network connection quality can include a connection quality of a current network, the current network being a cellular network or a wireless local area network (WLAN). In some implementations, the first interface can be further configured to obtain from a second wireless node a second frame while the apparatus is unassociated with the second wireless node, the second frame including a second indication of an internet connection quality between the second wireless node and the network.

In some implementations, the processing system can be further configured to: compare the first indication of the first frame to the second indication of the second frame, determine whether to associate with the first wireless node or the second wireless node based on the comparison of the first indication to the second indication, and generate an association request frame based on the determination, and the apparatus can further include a second interface configured to output the association request frame for transmission to the first wireless node or the second wireless node. In some implementations, the apparatus can further include a receiver configured to receive the first frame, wherein the apparatus is configured as a wireless node.

Certain aspects of the subject matter described in this disclosure can be implemented in an apparatus for wireless communication. In some implementations, the apparatus for wireless communication can include a processing system configured to generate a first frame including an indication of an internet connection quality between the apparatus and a network; and a transmitter configured to transmit the first frame to one or more wireless nodes that are unassociated with the apparatus.

Certain aspects of the subject matter described in this disclosure can be implemented in an apparatus for wireless communication. In some implementations, the apparatus for wireless communication can include a receiver configured to receive, from a first wireless node, a first frame while the apparatus is unassociated with the first wireless node, the first frame including a first indication of an internet connection quality between the first wireless node and a network; and a processing system configured to determine whether to associate with the first wireless node based at least in part on the first indication of the internet connection quality between the first wireless node and the network.

Certain aspects of the subject matter described in this disclosure can be implemented in a method for wireless communication. In some implementations, the method for wireless communication can include generating, at an apparatus, a first frame including an indication of an internet connection quality between the apparatus and a network; and outputting, at the apparatus, the first frame for transmission to one or more wireless nodes that are unassociated with the apparatus.

Certain aspects of the subject matter described in this disclosure can be implemented in a method for wireless communication. In some implementations, the method for wireless communication can include obtaining, at an apparatus, a first frame from a first wireless node while the apparatus is unassociated with the first wireless node, the first frame including a first indication of an internet connection quality between the first wireless node and a network; and determining, at the apparatus, whether to associate with the first wireless node based at least in part on the first indication of the internet connection quality between the first wireless node and the network.

Certain aspects of the subject matter described in this disclosure can be implemented an apparatus for wireless communication. In some implementations, the apparatus for wireless communication can include means for generating a first frame including an indication of an internet connection quality between the apparatus and a network; and means for outputting the first frame for transmission to one or more wireless nodes that are unassociated with the apparatus.

Certain aspects of the subject matter described in this disclosure can be implemented an apparatus for wireless communication. In some implementations, the apparatus for wireless communication can include means for obtaining from a first wireless node a first frame while the apparatus is unassociated with the first wireless node, the first frame including a first indication of an internet connection quality between the first wireless node and a network; and means for determining whether to associate with the first wireless node based at least in part on the first indication of the internet connection quality between the first wireless node and the network.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram of an example wireless communication system, in accordance with certain aspects of the present disclosure.

FIG. 2 is a diagram of an information element that indicates an internet connection quality, in accordance with certain aspects of the present disclosure.

FIG. 3 is a flow diagram illustrating example operations by a wireless device, in accordance with certain aspects of the present disclosure.

FIG. 4 is another flow diagram illustrating example operations by a wireless device, in accordance with certain aspects of the present disclosure.

FIG. 5 illustrates an example wireless device, in accordance with certain aspects of the present disclosure.

### DETAILED DESCRIPTION

The described features generally relate to advertising an internet connection quality. A first wireless node may be configured to estimate the internet connection quality and advertise the estimated internet connection quality to at least one second unassociated wireless node. Based on the advertised internet connection quality, the second wireless node can decide whether or not to associate with the first wireless node and establish a connection. According to some examples, the internet connection quality may be advertised in a frame, such as a beacon frame and/or a probe response frame.

In some examples, the first wireless node may generate an information element in the frame that indicates the internet connection quality. The information element may include various fields indicative of the quality of the internet connection. For instance, such fields may indicate an internet reachability, an internet connection round trip latency, an internet uplink remaining available bandwidth, and an internet downlink remaining available bandwidth, among other metrics. The second wireless node may receive the information element and compare the internet connection quality of the first wireless node to its current internet connection quality and/or an internet connection quality advertised by one or more other wireless nodes. Based on the comparison, the second wireless node may determine whether to associate with the first wireless node. The second wireless node may use other information, such as information obtained from a Quality of Service (QOS) Basic Service Set (BSS) Load information element, in conjunction with the advertised internet connection quality of the first wireless node to determine whether to associate with the first wireless node.

The following description provides examples, and is not limiting of scope, applicability, or configuration set forth in the claims. The following description is directed to certain implementations for the purposes of describing the innovative aspects of this disclosure. However, a person having ordinary skill in the art will readily recognize that the teachings herein can be applied in a multitude of different ways. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer-readable media, and methods disclosed herein, whether implemented independently of, or combined with, any other aspect of the features described. For example, an apparatus may be implemented or a method may be practiced using any number of the aspects set forth herein. In addition, the scope of the disclosure is intended to cover such an apparatus or method, which is practiced using other structure, functionality, or structure and functionality in addition to or other than the various aspects of the disclosure set forth herein. It should be understood that any aspect disclosed herein may be embodied by one or more elements of a claim.

The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G, or 5G, or further implementations thereof, technology.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and may be used to transmit wireless signals across a relatively long range, for example about one kilometer or longer.

In some implementations, a WLAN includes various devices, or wireless nodes, which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (such as the IEEE 802.11 protocol) compliant wireless link to obtain general connectivity to the Internet or to other wide area networks. In some implementations, a STA may also be used as an AP.

The Internet may refer to a network of networks and/or the global system of interconnected computer networks. The Internet uses the Internet protocol suite to connect various devices worldwide. The Internet protocol suite is a set of communications protocols commonly known as TCP/IP due to the Transmission Control Protocol (TCP) and the Internet Protocol (IP) being the foundational protocols in the suite. The Internet may include private, public, academic, business, and/or government networks of local to global scope. The networks may be connected via various electronic, wireless, and/or optical networking technologies. In addition, the Internet carries information resources and services of the World Wide Web (WWW), electronic mail, Voice over IP (VoIP), file sharing, and other applications.

An AP may also include, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A STA may also include, be implemented as, or known as an access terminal (AT), a subscriber station, a subscriber unit, a mobile station, a remote station, a remote terminal, a user terminal, a user agent, a user device, a user equipment, or some other terminology. In some implementations, a station may include a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (such as a cellular phone or smartphone), a computer (such as a laptop), a portable communication device, a headset, a portable computing device (such as a personal data assistant), an entertainment device (such as a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that utilizes an “association request” by one of the apparatus followed by an “association response” by the other apparatus. It will be understood by those skilled in the art that the handshake protocol may utilize other signaling, such as by way of example, signaling to provide authentication.

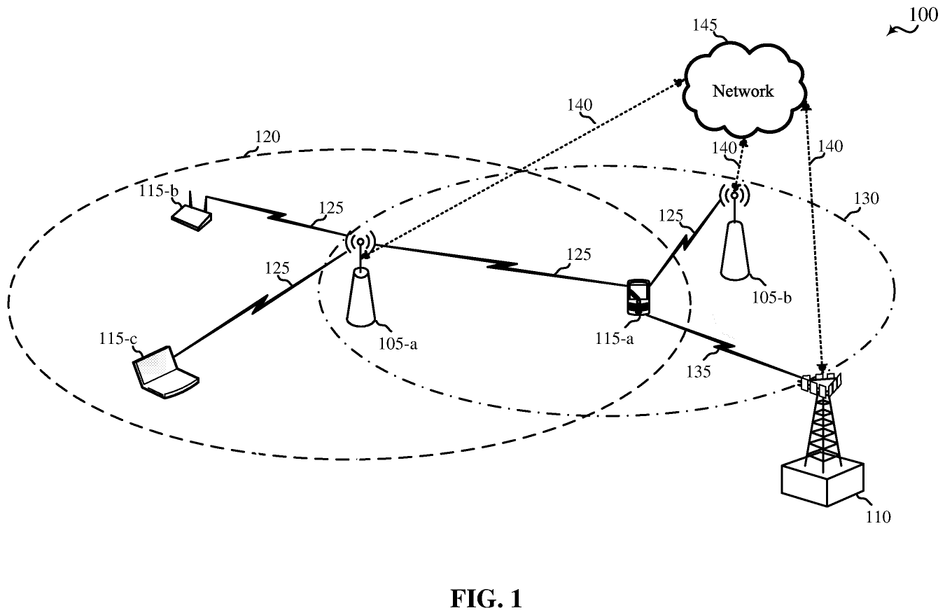

Referring first to FIG. 1, a block diagram illustrates an example of a wireless communication system 100 which may provide access to one or more WLANs and/or WANs. The wireless communication system 100 may include WLAN or WiFi access points (APs) 105 and wireless client devices 115. WLAN or WiFi APs 105 may provide network access according to wireless protocols that, for example, adhere to at least one of the IEEE 802.11 family of standards. The wireless communication system 100 may also include cellular base stations 110 which may provide cellular communications with one or more of the client devices 115. While only two APs 105-a and 105-b are illustrated, additional APs may exist in various examples or less than two APs may exist in various examples. Likewise, while only one base station 110 is illustrated, additional base stations may exist in various examples or no base stations may exist in various examples.

The client devices 115, also referred to as wireless stations, stations, or STAs, may be distributed or deployed within a coverage area 120 or 130 of access points 105-a or 105-b, respectively. Each of the STAs 115 may associate and communicate using communication links 125 with one of the APs 105, and/or may associate and communicate using communication links 135 with base station 110. As illustrated in FIG. 1, a STA 115-a may be covered by more than one AP 105 and can therefore associate with different APs 105 and/or different WANs through the different APs 105 or base station 110 at different times depending on which one provides a more suitable connection. A single AP 105 and an associated set of STAs 115 may be referred to as a basic service set (BSS). An extended service set (ESS) is a set of connected BSSs. A distribution system (DS) (not shown) is used to connect access points in an extended service set.

The AP 105 may wirelessly communicate with the STAs 115 via one or more antennas. The AP 105 may communicate with the STAs 115 under the control of an AP controller (not shown) via multiple carriers. Each AP 105 may provide communication coverage for a respective geographic area. In some embodiments, an AP 105 may be referred to as a base station, a radio base station, a wireless node, a wireless device, a basic service set (BSS), an extended service set (ESS), or some other suitable terminology. A coverage area for an AP 105 may be divided into sectors making up only a portion of the coverage area (not shown). The wireless communication system 100 may include APs 105 of different types (e.g., metropolitan area, home network, etc.), with varying sizes of coverage areas and overlapping coverage areas for different technologies.

The STAs 115 may be dispersed throughout the coverage areas 120, 130. Each STA 115 may be stationary or mobile. In one configuration, the STAs 115 may be able to communicate with different types of APs 105 via links 125, or with one or more different base station(s) 110 via links 135. The STAs 115 may be referred to as mobile stations (MSs), mobile devices, stations (STAs), wireless nodes, wireless devices, access terminals (ATs), user equipment (UE), subscriber stations (SSs), or subscriber units. The STAs 115 may include cellular phones and wireless communications devices, but may also include personal digital assistants (PDAs), other handheld devices, wearable devices, netbooks, notebook computers, tablet computers, etc. While only three STAs 115-a, 115-b, and 115-c are illustrated, additional STAs may exist in various examples or less than three STAs may exist in various examples.

The communication links 125 shown in the wireless communication system 100 may include uplinks (ULs) for uplink transmissions from a STA 115 to an AP 105, and/or downlinks (DLs) for downlink transmissions, from an AP 105 to a STA 115. Similarly, communication link 135 shown in the wireless communication system 100 may include uplinks (ULs) for uplink transmissions from a STA 115 to a base station 110, and/or downlinks (DLs) for downlink transmissions, from a base station 110 to a STA 115. The downlink transmissions may also be called forward link transmissions, while the uplink transmissions may also be called reverse link transmissions.

Each of the APs 105 may be configured to communicate via a wired or wireless communication channel 140 with a network 145, such as the Internet or other network. The APs 105 may provide network access, such as an internet connection, to the STAs 115. For instance, each of the STAs 115 may connect to the AP 105 via a WiFi compliant wireless link, such as one of the IEEE 802.11 protocols, to obtain general connectivity to the Internet or to other wide area networks. The base station 110 may also be configured to communicate via a wired or wireless communication channel 140 with the network 145, such as the Internet or other network. The base station 110 may provide to the STAs 115 network access, such as an internet connection and/or access to a wireless wide area network (WWAN) through a cellular data service provider.

According to some examples, an AP 105 is configured to determine or estimate an internet connection quality. For instance, the AP 105 may estimate a quality of the wireless communication channel 140 to the network 145, such as the Internet. The AP 105 may generate a frame to advertise the internet connection quality estimation to each of the STAs 115. Such frame may include an indication of the internet connection quality between the AP 105 and the network 145. In some examples, the frame is a beacon frame that is broadcast to each of the STAs 115 by the AP 105. In some examples, the frame is a probe response frame that is generated in response to a probe request frame received from one of the STAs 115. The AP 105 may transmit the frame to one or more STAs 115 that are unassociated with the AP 105. By transmitting the frame with its internet connection quality estimation to one or more unassociated STAs 115, the AP 105 may provide each of the STAs 115 with useful information to assist in determining whether or not to associate and establish a connection with the AP 105.

The one or more STAs 115 can use the internet connection quality estimation advertised from the AP 105, such as in a beacon frame and/or a probe response frame, to ensure a reliable internet connection. Instead of first connecting to the AP 105 and then performing internet reachability and connection quality testing, the one or more STAs 115 can efficiently obtain the internet connection quality estimation from the beacon frame, probe response frame, or any other frame without having to associate and establish a connection with the AP 105. More specifically, the one or more STAs 115 may be configured to receive the internet connection quality estimation from the AP 105 and make productive steering decisions between various APs and/or between various cellular and WiFi networks without having to connect to any of the APs. In so doing, a STA can assess the quality of an AP's network or internet connection and avoid connecting with an AP that has an unreliable network or internet connection.

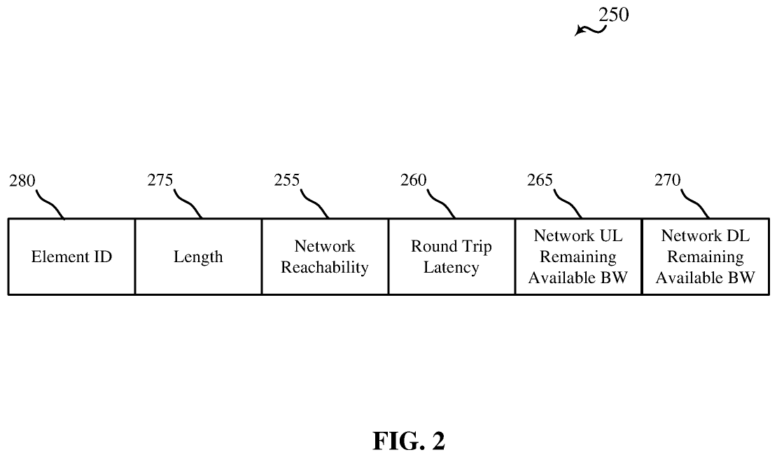

According to some examples, the frame, such as the beacon frame and/or the probe response frame, may include an information element that indicates the internet connection quality estimation. For instance, the AP 105 may be configured to generate the information element and include the information element in the beacon frame, the probe response frame, or any other type of frame. An example of an information element 250 that indicates an internet connection quality is shown in FIG. 2. According to some examples, the information element 250 includes a first field 255 indicating a network reachability of the AP 105 to the network 145, a second field 260 indicating a round trip latency of the AP 105 to the network 145, a third field 265 indicating a network uplink remaining available bandwidth, and a fourth field 270 indicating a network downlink remaining available bandwidth. Although the information element 250 includes four fields 255, 260, 265, and 270, different numbers of fields and/or different types of fields may be used to indicate the internet connection quality between the AP 105 and the network 145.

In some examples, the first field 255 may indicate whether or not the AP 105 can reach the network 145. The AP 105 may be configured to perform an internet reachability test to determine the network reachability. For instance, the AP 105 may send a first packet to the network 145 and may receive a second packet from the network 145 in response to sending the first packet. Upon receiving the second packet from the network 145, the AP 105 may determine that it is connected to the network 145, and therefore, indicate that there is network reachability in the first field 255 of the information element 250. If the AP 105 does not receive a second packet from the network 145 in response to sending the first packet, then the AP 105 may determine that it is not connected to the network 145, and therefore, indicate that there is no network reachability in the first field 255 of the information element 250.

Network reachability testing may include, for example, Domain Name System (DNS) lookup, Ping, Internet Control message Protocol (ICMP), or other protocols. In an example, the signaling of the network reachability of the AP 105 of the information element 250 may comprise one bit with a value of “0” indicating no network reachability, or no access to the internet, and a value of “1” indicating network reachability, or there is access to the internet. However, other configurations for the network reachability of the AP 105 in the first field 255 may be used.

In some examples, the second field 260 may indicate the round trip latency of the AP 105 to the network 145. The AP 105 may be configured to measure a round trip time of a packet to and from the network 145 to determine the round trip latency. For instance, the AP 105 may be configured to measure a round trip time or duration from when the AP 105 sends the first packet to the network 145 to when the AP 105 receives the second packet from the network 145. Ping and/or other protocols may be used to measure the round trip latency. In some examples, the AP may measure the round trip latency in milliseconds and indicate the same in the second field 260 of the information element 250. The signaling of the round trip latency may comprise fifteen bits, although any number of bits may be used to signal the round trip latency in the information element 250. According to some examples, the first field 255 indicating the network reachability and the second field 260 indicating the round trip latency may together comprise two bytes. However, other configurations for the first field 255 and the second field 260 may be used.

According to some examples, the third field 265 may indicate the network uplink remaining available bandwidth. The AP 105 may be configured to measure a throughput from the AP 105 to the network 145 to determine the network uplink remaining available bandwidth. For instance, the AP 105 may make a web request, such as a POST request method, that requests the network 145 to accept data and may receive an acknowledgement from the network 145 when all of the data has been accepted. In this example, the AP 105 may measure a time or duration from when the AP 105 sends the POST web request to when the AP 105 receives the acknowledgement. For the network uplink remaining available bandwidth, the AP 105 can divide the amount of data that is sent by the measured time to determine the throughput from the AP 105 to the network 145. In some examples, the AP 105 may estimate the uplink remaining available bandwidth in kilobits per second and indicate the same in the third field 265 of the information element 250. The third field 265 indicating the network uplink remaining available bandwidth may comprise four bytes, although other configurations for the third field 265 may be used.

According to some examples, the fourth field 270 may indicate the network downlink remaining available bandwidth. The AP 105 may be configured to measure a throughput from the network 145 to the AP 105 to determine the downlink remaining available bandwidth. For instance, the AP 105 may make a web request, such as a GET request method, that requests the network 145 to retrieve data. In this example, the AP 105 may measure a time or duration from when the AP 105 sends the GET web request to when the AP 105 receives the retrieved data. For the downlink remaining available bandwidth, the AP 105 can divide the amount of data that is received by the measured time to determine the throughput from the network 145 to the AP 105. In some examples, the AP 105 may estimate the downlink remaining available bandwidth in kilobits per second and indicate the same in the fourth field 270 of the information element 250. The fourth field 270 indicating the network downlink remaining available bandwidth may comprise four bytes, although other configurations for the fourth field 270 may be used.

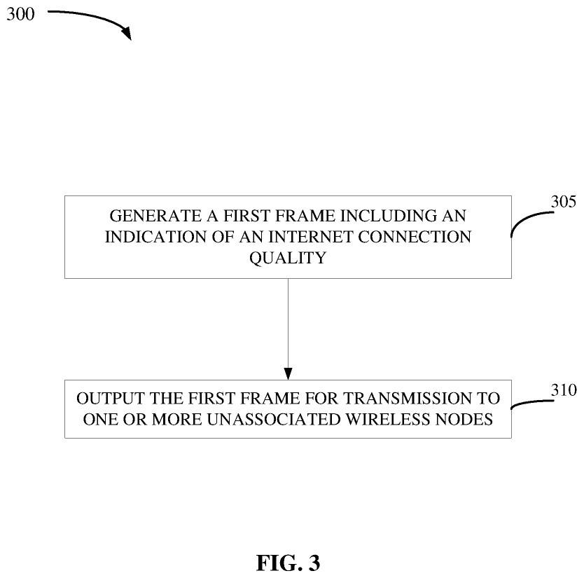

The information element 250 may also include an element identifier (ID) 275 and a length 280. The element ID 275 and the length 280 of the information element 250 may precede the first field 255 and may each comprise one byte. However, other configurations for the element ID and the length may be used. Furthermore, it is to be understood that the information element 250 is not limited to the type, order, number, and/or names of the fields 255, 260, 265, 270, 275, and 280 as described and shown in FIG. 3. Other parameters and metrics may be measured, determined, or estimated and may be included in the information element 250 to indicate the internet connection quality of the AP 105.

According to some examples, a STA 115 may be configured to obtain the information element 250 from the beacon frame, the probe response frame, or other type of frame while unassociated with the AP 105. The STA 115 may be further configured to determine whether to associate with the AP 105 based at least in part on the indication of the internet connection quality between the AP 105 and the network 145. In addition, the STA 115 may be configured to use the indication of the internet connection quality between the AP 105 and the network 145 in conjunction with other information to make steering decisions. In some examples, the STA 115 may obtain a QoS BSS (QBSS) load information element (IE) from the AP 105, such as in accordance with IEEE 802.11e and 802.11k protocols. The QBSS load IE includes a station count, a channel utilization, and an available admission capacity of the AP 105. The STA 115 may be configured to determine whether to associate with the AP 105 based also on the load information in the QBSS load IE. The STA 115 may also use other information in addition to or as an alternative than the information found in the QBSS load IE.

In some examples, the STA 115 may use the QBSS load IE and the indication of the internet connection quality between the AP 105 and the network 145, such as in the information element 250, to determine a total internet connection quality between the STA 115 and the network 145. For instance, the load information from the QBSS load IE may provide a connection quality estimation from the STA 115 to the AP 105, and the internet connection quality indication, such as in the information element 250, may provide the internet connection quality estimation from the AP 105 to the network 145. In so doing, the STA 115 can determine the total internet connection quality from the STA 115 to the AP 105 to the network 145 using the QBSS load IE and the internet connection quality indication, such as in the information element 250. Moreover, the total internet connection quality from the STA 115 to the network 145, via the AP 105, may be determined without having to connect with the AP 105, or while the STA is unassociated with the AP 105.

The STA 115 may compare the total internet connection quality between the STA 115 and the network 145, via the AP 105, to a current network connection quality between the STA 115 and the network 145. The STA 115 may currently be connected to the network 145 via another AP or base station, and the current network connection quality may be a connection quality of the current WLAN or cellular network. While connected to the other AP or base station, the STA 115 can perform internet reachability and connection quality testing to obtain metrics indicative of the current network connection quality from the STA 115 to the network 145. In some examples, the STA 115 may be configured to obtain metrics indicative of network reachability, round trip latency, uplink remaining available bandwidth, and downlink remaining available bandwidth from the other AP or base station to the network 145 and/or from the STA 115 to the network 145. The STA 115 may be configured to compare such metrics to the metrics obtained from the QBSS load IE and the internet connection quality indication, such as in the information element 250. Based on the comparison of current network connection quality to the total internet connection quality via the AP 105, the STA 115 may determine whether to associate with the AP 105. The STA 115 may be configured to make the comparison and determination without using information from the QBSS load IE as well.

If the internet connection quality between the AP 105 and the network 145 and/or the total internet connection quality between the STA 115 and the network 145 via the AP 105 exceeds the current network connection quality of the current WLAN or cellular network, the STA 115 may determine to associate with the AP 105. For example, the network 145 may be reachable via the AP 105, and the AP 105 may have increased round trip latency, uplink remaining available bandwidth, and/or downlink remaining available bandwidth, as compared to that of the current network to which the STA 115 is connected. Based on the determination to associate with the AP 105, the STA 115 may generate and transmit an association request frame to the AP 105 and may establish a connection with the AP 105. In so doing, the STA 115 may acquire a more reliable network or internet connection with the AP 105 than the current network connection quality.

If the current network connection quality of the current WLAN or cellular network exceeds the internet connection quality between the AP 105 and the network 145 and/or the total internet connection quality between the STA 115 and the network 145 via the AP 105, the STA 115 may determine not to associate with the AP 105. For example, the network 145 may be unreachable via the AP 105 and/or the AP 105 may have decreased round trip latency, uplink remaining available bandwidth, and/or downlink remaining available bandwidth, as compared to that of the current network to which the STA 115 is connected. The STA 115 may refrain from associating with the AP 105 based on the determination to not associate with the AP 105. In so doing, the STA 115 may avoid making an unproductive and wasteful connection with the AP 105.

According to some examples, the STA 115 may compare internet connection quality indications between different APs in order to make optimal steering decisions. For instance, the STA 115-a may receive a first frame from a first AP 105-a and may receive a second frame from a second AP 105-b. The STA 115-a may not be associated with either of the first AP 105-a and the second AP 105-b. The first frame may include a first indication of an internet connection quality between the first AP 105-a and the network 145, and the first indication may be an information element 250 included in the first frame. The second frame may include a second indication of an internet connection quality between a second AP 105-b and the network 145, and the second indication may be an information element 250 included in the second frame. The STA 115-a may be configured to compare the first indication to the second indication, such as compare the metrics in each of the information elements of the first frame and the second frame. The network reachability, the round trip latency, the uplink remaining available bandwidth, and the downlink remaining available bandwidth of the first AP 105-a may be compared to that of the second AP 105-b.

Based on the comparison, the STA 115-a may decide whether to associate with the first AP 105-a or the second AP 105-b. If the metrics in the first indication of the internet connection quality between the first AP 105-a and the network 145 exceed the metrics in the second indication of the internet connection quality between the second AP 105-b and the network 145, the STA 115-a may decide to associate with the first AP 105-a and may generate and transmit an association request frame to the first AP 105-a. If the metrics in the second indication of the internet connection quality between the second AP 105-b and the network 145 exceed the metrics in the first indication of the internet connection quality between the first AP 105-a and the network 145, the STA 115-a may decide to associate with the second AP 105-b and may generate and transmit an association request frame to the second AP 105-b. In so doing, the STA 115-a may be configured to connect to an AP that has a reliable, high quality internet connection.

In some examples, the STA 115-a may further be configured to receive a QBSS load IE from the second AP 105-b and determine a total internet connection quality between the STA 115-a and the network 145 via the second AP 105-b. The STA 115-a may compare the total internet connection quality via the first AP 105-a to the total internet connection quality via the second AP 105-b in order to determine whether to associate with the first AP 105-a or the second AP 105-b. The STA 115-a may further be configured to compare the second indication and/or the total internet connection quality via the second AP 105-b to the current network connection quality. The STA 115-a may use such comparison(s) to decide whether to associate with the second AP 105-b. The STA 115-a may be configured to use other factors as well to make steering decisions.

Referring now to FIG. 3, a flowchart is shown illustrating a method 300 for wireless communication that may be employed within the wireless communication system 100 of FIG. 1. At block 305, a first frame may be generated at a wireless node, such as one of the APs 105 and/or the STAs 115. The first frame may include an indication of an internet connection quality between the wireless node and a network, such as the Internet or other network. In some examples, the wireless node may be configured to determine an internet connection quality, such as by measuring and estimating different metrics. Such metrics may include a network reachability, a round trip latency, a network uplink remaining available bandwidth, a network downlink remaining available bandwidth, and other parameters indicative of the internet connection quality. An information element may include various fields to indicate the one or more metrics indicative of the internet connection quality between the wireless node and the network. The information element may be included in a beacon frame and/or a probe response frame.

At block 310, the first frame may be output for transmission to one or more wireless nodes, such as to one or more of the STAs 115 and/or the APs 105. The one or more wireless nodes may be unassociated with the wireless node that generated and output the first frame. The one or more wireless nodes may use the first frame including the indication of the internet connection quality to make productive and efficient steering decisions. However, in some examples, the one or more wireless nodes may already be associated with the wireless node that generated and output the first frame. For instance, the first frame may be broadcast to provide an updated indication of the internet connection quality between the wireless node and the network.

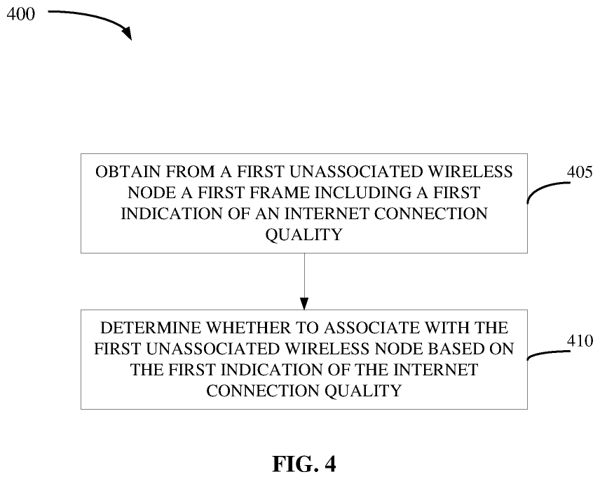

Referring now to FIG. 4, a flowchart is shown illustrating a method 400 for wireless communication that may be employed within the wireless communication system 100 of FIG. 1. At block 405, a first frame may be obtained at an apparatus, such as a wireless node, or one of the STAs 115 and/or the APs 105. The first frame may be obtained from a first wireless node, such as one of the APs 105 and/or the STAs 115, while the apparatus is unassociated with the first wireless node. The first frame may include a first indication of an internet connection quality between the first wireless node and a network. In some examples, the first indication may comprise an information element with various fields to indicate one or more metrics, such as, a network reachability, a round trip latency, a network uplink remaining available bandwidth, a network downlink remaining available bandwidth, and other parameters indicative of the internet connection quality. The first frame may be a beacon frame and/or a probe response frame.

At block 410, whether to associate with the first wireless node may be determined based at least in part on the first indication of the internet connection quality between the first wireless node and the network. In addition, a QBSS load information element may be obtained, and determining whether to associate with the first wireless node may be based at least in part on the QBSS load information element as well. In some examples, the QBSS load information element and the first indication of the internet connection quality between the first wireless node and the network may be used to determine a total internet connection quality between the apparatus and the network wile the apparatus is unassociated with the first wireless node. The total internet connection quality between the apparatus and the network may be compared to a current network connection quality between the apparatus and the network. Determining whether to associate to the first wireless node may be also based at least in part on the total internet connection quality and/or on the comparison of the total internet connection quality to the current network connection quality.

Other factors may be used to determine whether to connect to the first wireless node. In some examples, a second indication of an internet connection quality between a second wireless node and the network may be obtained from the second wireless node while the apparatus is unassociated with the second wireless node. The first indication of the internet connection quality between the first wireless node and the network may be compared to the second indication of the internet connection quality between the second wireless node and the network. Determining whether to associate with the first wireless node may also be based at least in part on the second indication of the internet connection quality between the second wireless node and the network and/or the comparison of the first indication to the second indication.

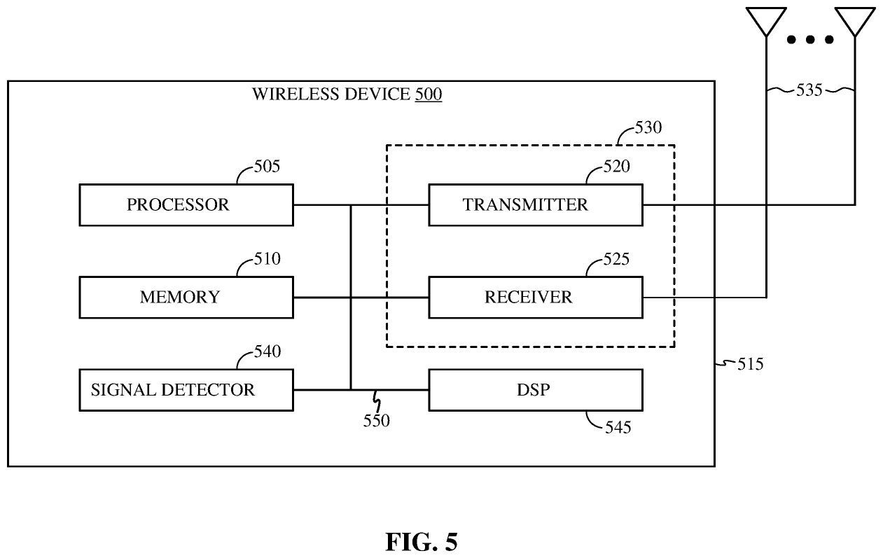

FIG. 5 illustrates various components that may be utilized in a wireless node or wireless device 500 that may be employed within the wireless communication system 100. The wireless device 500 is an example of a device that may be configured to implement the various methods described herein. For example, the wireless device may implement operations 300 and 400. The wireless device 500 may be an AP 105 and/or a STA 115.

The wireless device 500 may include a processor 505 which controls operation of the wireless device 500. The processor 505 may also be referred to as a central processing unit (CPU). Memory 510, which may include both read-only memory (ROM) and random access memory (RAM), provides instructions and data to the processor 505. A portion of the memory 510 may also include non-volatile random access memory (NVRAM). The processor 505 typically performs logical and arithmetic operations based on program instructions stored within the memory 510. The instructions in the memory 510 may be executable to implement the methods described herein.

The wireless device 500 may also include a housing 515 that may include a transmitter 520 and a receiver 525 to allow transmission and reception of data between the wireless device 500 and a remote node. The transmitter 520 and receiver 525 may be combined into a transceiver 530. A single or a plurality of transmit antennas 535 may be attached to the housing 515 and electrically coupled to the transceiver 530. The wireless device 500 may also include (not shown) multiple transmitters, multiple receivers, and multiple transceivers.

The wireless device 500 may also include a signal detector 540 that may be used in an effort to detect and quantify the level of signals received by the transceiver 530. The signal detector 540 may detect such signals as total energy, energy per subcarrier per symbol, power spectral density and other signals. The wireless device 500 may also include a digital signal processor (DSP) 545 for use in processing signals.

The various components of the wireless device 500 may be coupled together by a bus system 550, which may include a power bus, a control signal bus, and a status signal bus in addition to a data bus.

The various operations of methods described above may be performed by any suitable means capable of performing the corresponding functions. The means may include various hardware and/or software component(s) and/or module(s), including, but not limited to a circuit, an application specific integrated circuit (ASIC), or a processor. Generally, where there are operations illustrated in figures, those operations may have corresponding counterpart means-plus-function components with similar numbering.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a station 115 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-Ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. In certain aspects, the computer program product may include packaging material.

Further, it should be appreciated that modules and/or other appropriate means for performing the methods and techniques described herein can be downloaded and/or otherwise obtained by a station and/or access point as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a station and/or access point can obtain the various methods upon coupling or providing the storage means to the device. Moreover, any other suitable technique for providing the methods and techniques described herein to a device can be utilized.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a processing system configured to generate a first frame including an indication of an internet connection quality between the apparatus and a network; and
a first interface configured to output the first frame for transmission to one or more wireless nodes that are unassociated with the apparatus.

2. The apparatus of claim 1, wherein the first frame includes an information element, the information element including the indication of the internet connection quality between the apparatus and the network.

3. The apparatus of claim 2, wherein the information element includes at least one of a first field indicating a network reachability of the apparatus to the network, a second field indicating a round trip latency of the apparatus to the network, a third field indicating a network uplink remaining available bandwidth, or a fourth field indicating a network downlink remaining available bandwidth.

4. The apparatus of claim 3, wherein the processing system is further configured to perform an internet reachability test to determine the network reachability.

5. (canceled)

6. The apparatus of claim 3, wherein the processing system is further configured to measure a round trip time of a packet to and from the network to determine the round trip latency.

7. (canceled)

8. The apparatus of claim 3, wherein the processing system is further configured to measure a throughput from the apparatus to the network to determine the network uplink remaining available bandwidth.

9. (canceled)

10. The apparatus of claim 3, wherein the processing system is further configured to measure a throughput from the network to the apparatus to determine the downlink remaining available bandwidth.

11. The apparatus of claim 1, wherein the first frame comprises a beacon frame.

12. The apparatus of claim 1, further comprising a second interface configured to obtain a second frame from the one or more wireless nodes, the second frame comprising a probe request, and the first frame comprising a probe response.

13. The apparatus of claim 1, further comprising:
a transmitter configured to transmit the first frame, wherein the apparatus is configured as a wireless node.

14. An apparatus for wireless communication, comprising:
a first interface configured to obtain from a first wireless node a first frame while the apparatus is unassociated with the first wireless node, the first frame including a first indication of an internet connection quality between the first wireless node and a network; and
a processing system configured to determine whether to associate with the first wireless node based at least in part on the first indication of the internet connection quality between the first wireless node and the network.

15. The apparatus of claim 14, wherein the first frame includes an information element, the information element including the first indication of the internet connection quality between the apparatus and the network.

16. The apparatus of claim 15, wherein the information element includes at least one of a first field indicating a network reachability of the apparatus to the network, a second field indicating a round trip latency of the apparatus to the network, a third field indicating a network uplink remaining available bandwidth, or a fourth field indicating a network downlink remaining available bandwidth.

17-19. (canceled)

20. The apparatus of claim 14, wherein the first interface is further configured to obtain from the first wireless node a QBSS load information element, and wherein the processing system is further configured to determine whether to associate with the first wireless node based at least in part on the QBSS load information element.

21. The apparatus of claim 20, wherein the processing system is further configured to:
use the QBSS load information element and the first indication of the internet connection quality between the first wireless node and the network to determine a total internet connection quality between the apparatus and the network while the apparatus is unassociated with the first wireless node, and
determine whether to associate with the first wireless node based at least in part on the total internet connection quality between the apparatus and the network.

22. The apparatus of claim 21, wherein the processing system is further configured to:
compare the total internet connection quality between the apparatus and the network to a current network connection quality between the apparatus and the network, and
determine whether to associate with the first wireless node based on the comparison of the total internet connection quality to the current network connection quality.

23. The apparatus of claim 22, wherein the processing system is further configured to generate an association request frame based on a determination to associate with the first wireless node, and wherein the apparatus further comprises a second interface configured to output the association request frame for transmission to the first wireless node.

24. The apparatus of claim 22, wherein the processing system is further configured to refrain from associating with the first wireless node based on a determination to not associate with the first wireless node.

25. The apparatus of claim 22, wherein the current network connection quality comprises a connection quality of a current network, the current network being a cellular network or a wireless local area network (WLAN).

26. The apparatus of claim 14, wherein the first interface is further configured to obtain from a second wireless node a second frame while the apparatus is unassociated with the second wireless node, the second frame including a second indication of an internet connection quality between the second wireless node and the network.

27. The apparatus of claim 26, wherein the processing system is further configured to:
compare the first indication of the first frame to the second indication of the second frame;
determine whether to associate with the first wireless node or the second wireless node based on the comparison of the first indication to the second indication; and
generate an association request frame based on the determination; and wherein the apparatus further comprises a second interface configured to output the association request frame for transmission to the first wireless node or the second wireless node.

28. The apparatus of claim 14, further comprising a receiver configured to receive the first frame, wherein the apparatus is configured as a wireless node.

29. An apparatus for wireless communication, comprising:
a processing system configured to generate a first frame including an indication of an internet connection quality between the apparatus and a network; and
a transmitter configured to transmit the first frame to one or more wireless nodes that are unassociated with the apparatus.

30-60. (canceled)
